(19) United States
(12) Patent Application Publication
(10) Pub. No.: US 2014/0250650 A1
(43) Pub. Date: Sep. 11, 2014

(54) BEARING INSTALLER FOR HUB

(71) Applicant: SINMAT TECHNOLOGY CORPORATION, Hsinchu County (TW)

(72) Inventor: Wen-Nan LEE, HSINCHU COUNTY (TW)

(73) Assignee: SINMAT TECHNOLOGY CORPORATION, HSINCHU COUNTY (TW)

(21) Appl. No.: 13/790,761

(22) Filed: Mar. 8, 2013

(51) Int. Cl. B25B 33/00

(52) U.S. Cl. CPC B25B 33/00
USPC 29/259

(57) ABSTRACT

A bearing installer for hub includes a threaded rod and a pushing device. The pushing device includes a pushing element. The threaded rod is inserted through a through hole of a sleeve tube or the pushing element, an axle, and an axle hole of the hub. A bearing is sleeved onto the sleeve tube or the axle. The pushing device is screwed to the threaded rod. When the pushing device is moved along the threaded rod, the bearing is pushed by the pushing device into a receiving room of the hub. Thereby, the bearing may not contact the threaded rod so that the bearing and the threaded rod are not abraded. Also, the hub is prevented from shaken so that the bearing is easier to be positioned.

### BACKGROUND OF THE INVENTION

1. Field of the Invention

The present invention relates to a bearing installer for hub.

2. Description of the Prior Art

A bearing is usually installed to a hub by a striking tool. However, the balls inside the bearing may be damaged, and relationship of distance between the balls, the inner ring, and the outer ring is changed so that the bearing is unable to operate smoothly.

To solve the previous problem, a conventional bearing installing tool has a threaded rod for inserting through the axle hole of the hub. The bearing and a pushing element are sleeved onto the threaded rod, and the pushing element is rotated to move along the threaded rod and further pushes the bearing to a predetermined position.

However, when the bearing is being moved into the hub or when removing the threaded rod, the bearing may be abraded by the threaded rod to result damage.

Moreover, the threaded rod has an external diameter smaller than the internal diameter of the axle hole of the hub so that the threaded rod is unable to be positioned in the axle hole and may be shaken. That is, the bearing is unable to be moved into the hub easily.

Besides, the pushing element is ring-shaped and is unable to be operated easily. Usually, the threaded rod forms a head portion at an end, and a tool is inserted into the head portion to drive the threaded rod to rotate with respect to the pushing element. Thereby, the bearing is pushed into the hub. That is, without appropriate tools, the bearing is unable to be installed into the hub.

### SUMMARY OF THE INVENTION

The main object of the present invention is to provide a bearing installer for hub whose threaded rod may not contact the bearing.

Another object of the present invention is to provide a bearing installer for hub whose threaded rod may not be shaken with respect to the hub so that the bearing is able to be moved into the hub easily.

To achieve the above and other objects, a bearing installer for hub of the present invention is provided. The bearing installer for hub is adapted for installing a bearing into a hub including a receiving room and axle hole wherein the receiving room is formed at an end of the hub and communicates with the axle hole. The bearing installer for hub of the present invention includes a sleeve tube, a threaded rod, and a pushing device.

The sleeve tube is detachably inserted into the receiving room and the axle hole. At least one end of the sleeve tube is protruded above an end of the hub and is adapted for a bearing to be sleeved onto. The sleeve tube forms a through hole.

The threaded rod is inserted into the through hole of the sleeve tube and has an external diameter substantially equal to an internal diameter of the sleeve tube.

The pushing device is screwed to the threaded rod. The pushing device is able to be moved along the threaded rod so that the bearing can be pushed by the pushing device along the sleeve tube into the receiving room of the hub.

Another bearing installer for hub of the present invention is provided. The bearing installer is adapted for installing a bearing into a hub including a receiving room, an axle, and an axle hole. The receiving room is formed at an end of the hub. The axle is axially protruded from a face of the receiving room near the axle hole and surrounds the axle hole. The bearing is slidably sleeved onto the axle. The axle forms a through hole communicating with the axle hole. The bearing installer for hub includes a threaded rod and a pushing device.

The threaded rod is inserted into the through hole of the axle and the axle hole of the hub.

The pushing device includes a pushing element and a rotating element. The pushing element forms a large hole and a reduced hole wherein the large hole communicates with the reduced hole. The axle is inserted through the large hole, and the threaded rod is inserted through the large hole and the reduced hole. The rotating element is screwed to the threaded rod and is able to move along the threaded rod toward the bearing or away from the bearing. The rotating element is able to be moved along the threaded rod so that the pushing element is pushed by the rotating element to move along the axle toward the bearing until the bearing is pushed into the receiving room. Specifically, an internal diameter of the reduced hole is substantially equal to an external diameter of the threaded rod.

Thereby, the bearing and the pushing element may not contact the threaded rod because they are sleeved onto the sleeve tube and the axle respectively. Thus, inner surfaces of the bearing and the pushing element and threads of the threaded rod may not be abraded. In addition, the sleeve tube and the pushing element help stabilize the whole structure to prevent the hub from shaking. Thus, the bearing is easier to be positioned into the receiving room.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a first embodiment of the present invention;

FIG. 2 is a stereogram showing a first embodiment of the present invention;

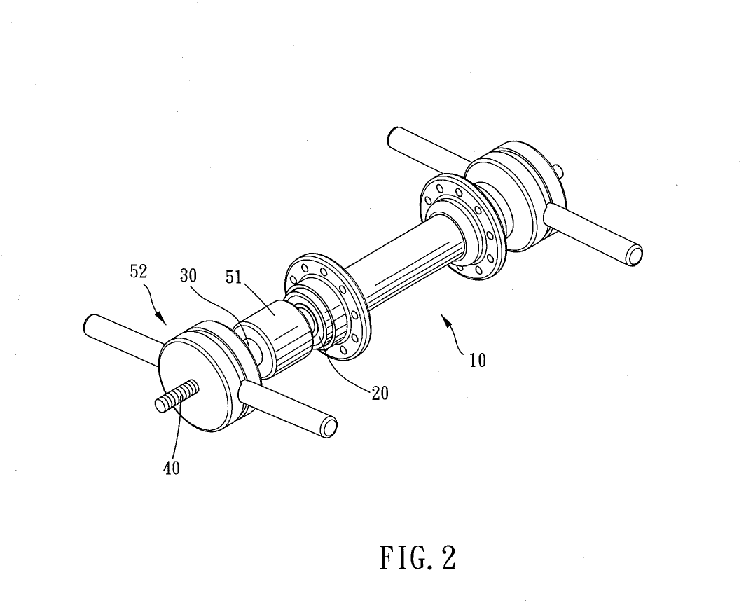

FIG. 3 is an illustration showing a first embodiment of the present invention;

FIG. 4 is an illustration showing a first embodiment of the present invention when a bearing is pushed into a receiving room of a hub;

FIG. 5 is a breakdown drawing showing a second embodiment of the present invention;

FIG. 6 is a stereogram showing a second embodiment of the present invention;

FIG. 7 is an illustration showing a second embodiment of the present invention;

FIG. 8 is an illustration showing a second embodiment of the present invention when a bearing is pushed into a receiving room of a hub.

### DETAILED DESCRIPTION OF THE PREFERRED EMBODIMENTS

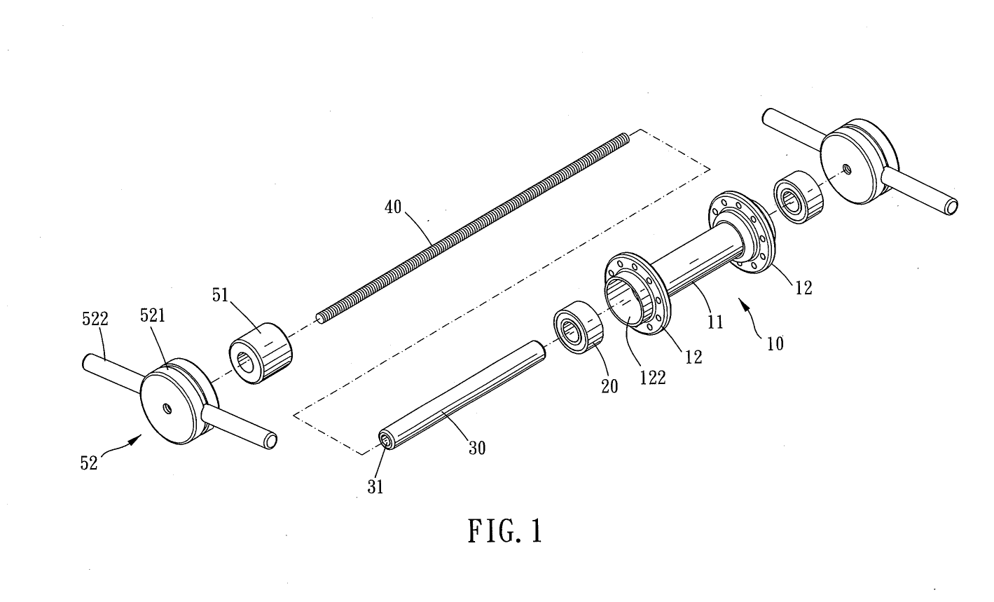

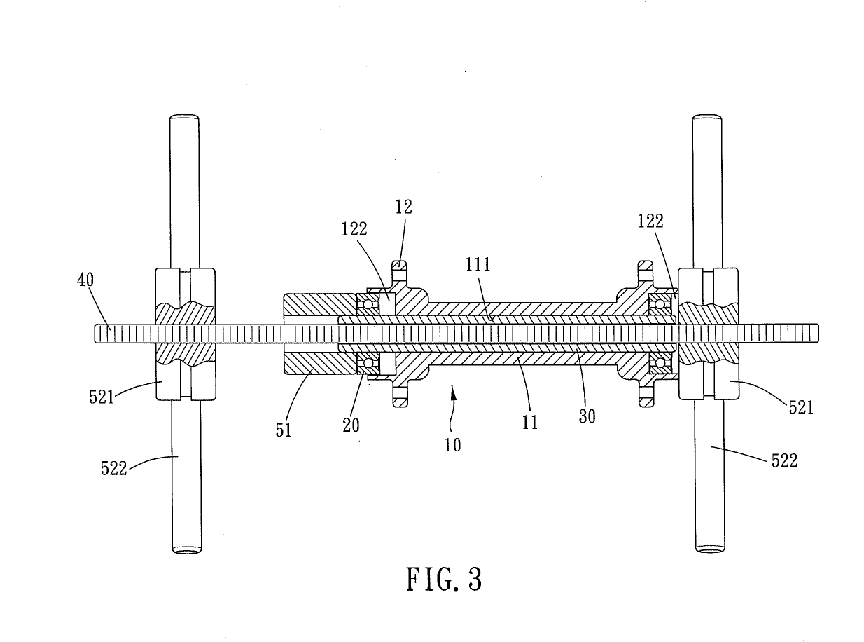

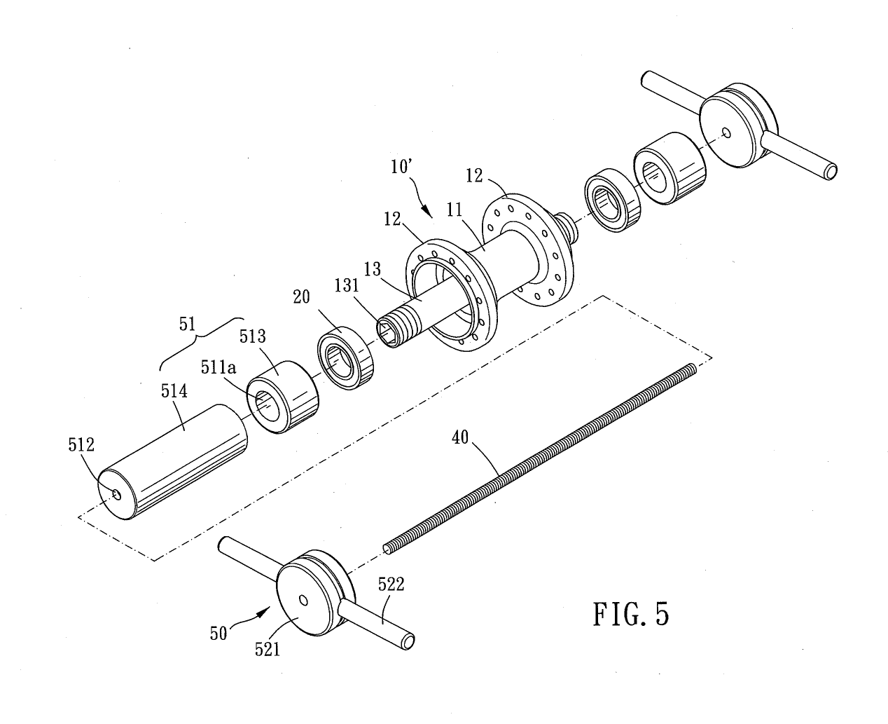

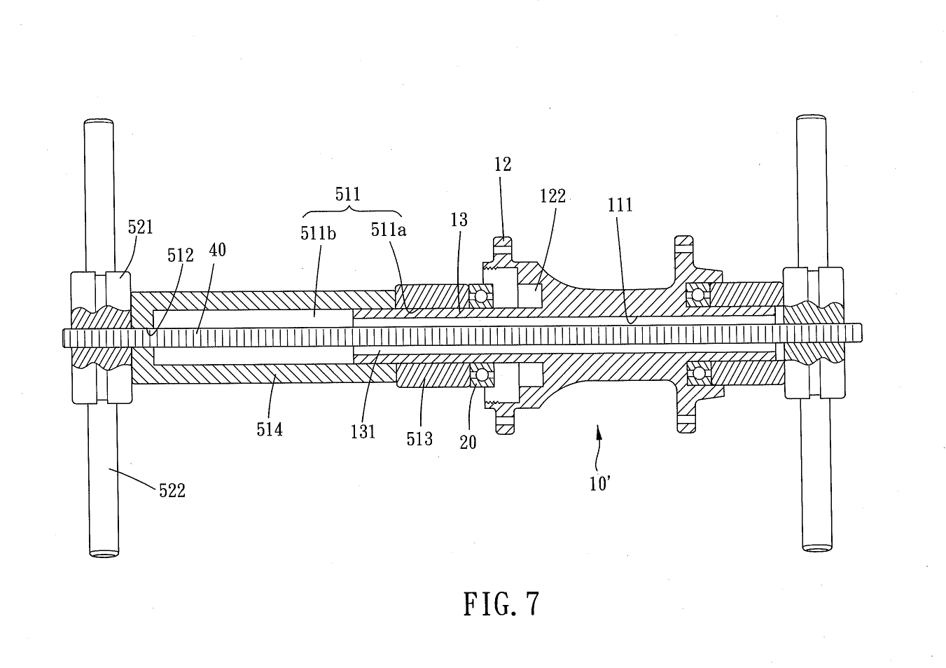

Please refer to FIGS. 1, 3, 5, and 7. A conventional hub 10 of bicycle includes a connecting portion 11, disk members 12, and an axle 13. The connecting portion 11 connects the two disk members 12 and forms an axle hole 111. Each disk member forms a plurality of spoke holes for spokes to be inserted in. Each disk member 12 recessedly forms a receiving room 122. Specifically, the two receiving rooms 122 are located at two opposite ends of the hub 10. Conventional hubs have various arrangements of axle. Axle hole 111 of the connecting portion 11 of one of conventional hubs 10 communicates the two receiving rooms 122 so that the axle is detachably inserted into the receiving room and the axle hole, as shown in FIGS. 1 and 3, wherein the axle is not shown. Axle 13 and disk members of another kind of hubs 10′ are formed integrally, as shown in FIGS. 5 and 7. To conclude, axle of a conventional hub forms external threads on an outer surface for other components of bicycle to be positioned on.

Please refer to FIGS. 1 and 3 for a preferable embodiment of the present invention, the bearing installer for hub is adapted for installing two bearings 20 onto a hub 10 having detachable axle. The bearing installer for hub includes a sleeve tube 30, a threaded rod 40, and two pushing devices.

The sleeve tube 30 is detachably disposed into the two receiving rooms 122 and the axle hole 111. Two ends of the sleeve tube 30 are protruded above two ends of the hub 10, the two disk members 12. The two bearings 20 are sleeved onto the two ends of the sleeve tube 30. Preferably, the sleeve tube 30 has a smooth outer surface without protrusions such as threads. The sleeve tube has an external diameter substantially equal to an internal diameter of the axle hole 111. Thereby, the sleeve tube 30 is positioned at the axle hole 111 to be prevented from being shaken. In addition, the sleeve tube 30 forms a through hole 31.

The threaded rod 40 is inserted into the through hole 31 of the sleeve tube 30 and has an external diameter substantially equal to an internal diameter of the through hole 31 of the sleeve tube 30. Thereby, the threaded rod 40 is positioned in the sleeve tube 30 to be prevented from being shaken.

The pushing device includes two pushing elements 51 and two rotating elements 52. Each pushing element 51 is slidably disposed to the sleeve tube 31. Each rotating element 52 includes a rotating body 521 and two shafts 522. Each rotating body 521 is screwed to the threaded rod 40 and is able to move along the threaded rod 40 toward or away from one of the bearings 20. Each shaft 522 is protruded above an end of the rotating body 521. The two shafts 522 extend parallely and are both perpendicular to an axial direction of the rotating body 521.

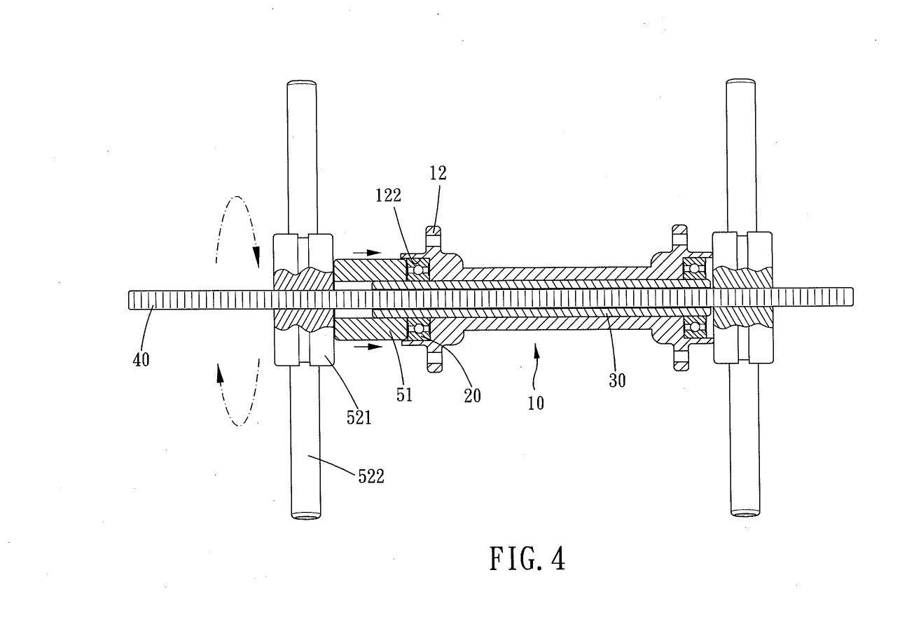

Please refer to FIGS. 3 and 4, before the bearing 20 is installed, the rotating body 521 of one of the rotating elements 52 is screwed to an end of the threaded rod 40 and abuts against one of the disk member 12. Thereafter, one of the bearings 20 and one of the pushing elements 51 are sleeved onto the sleeve tube 30, and the rotating body 521 of another rotating element is screwed to another end of the threaded rod 40. And then, the two shafts 522 are adapted for being held by a user to rotate the rotating body 521 so that the rotating body 521 moves along the threaded rod 40 toward the bearing 20. When the rotating body 521 pushes the pushing element 51, the pushing element 51 is moved along the sleeve tube 30 toward the bearing 20 until the bearing 20 is pushed into the receiving room 122 by the pushing element 51.

As disclosed previously, the hub 10′ is shown in FIGS. 5 and 7. The hub 10′ includes two axles 13, each of which is integrally and axially protruded from an internal surface of one of the receiving rooms 122 near the axle hole 111 and surrounds the axle hole 111. The two bearings 20 are slidably sleeved onto external surfaces of the two axes 13. Each axle 13 forms a through hole 131 communicating with the axle hole 111.

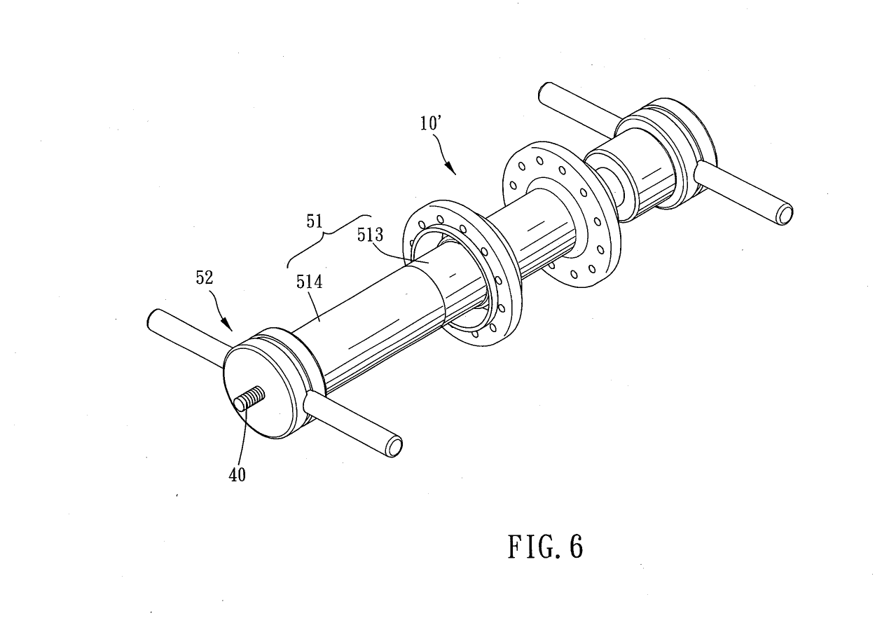

Please refer to FIGS. 5 to 7 for another embodiment of the present invention, the bearing installer for hub is adapted for installing the two bearings 20 onto the hub 10′, the two axes 13 and the two disk members 12. That is, in the present embodiment, the sleeve tube is not introduced. The threaded rod 40 is inserted into the through holes 131 of the axes 13 and the axle hole 111. The pushing device includes two pushing elements 51 and two rotating elements 52. Specifically, each pushing element 51 forms a large hole 511 and a reduced hole 512 which communicate with each other. Preferably, the large hole 511 includes a first section 511a and a second section 511b. Each pushing element 51 includes a first column 513 and a second column 51. The first section 511a of the large hole 511 is formed in the first column 513, and the second section 511b of the large hole 511 and the reduced hole 512 are formed in the second column 514 wherein the reduced hole 512 communicates with the second section 511b.

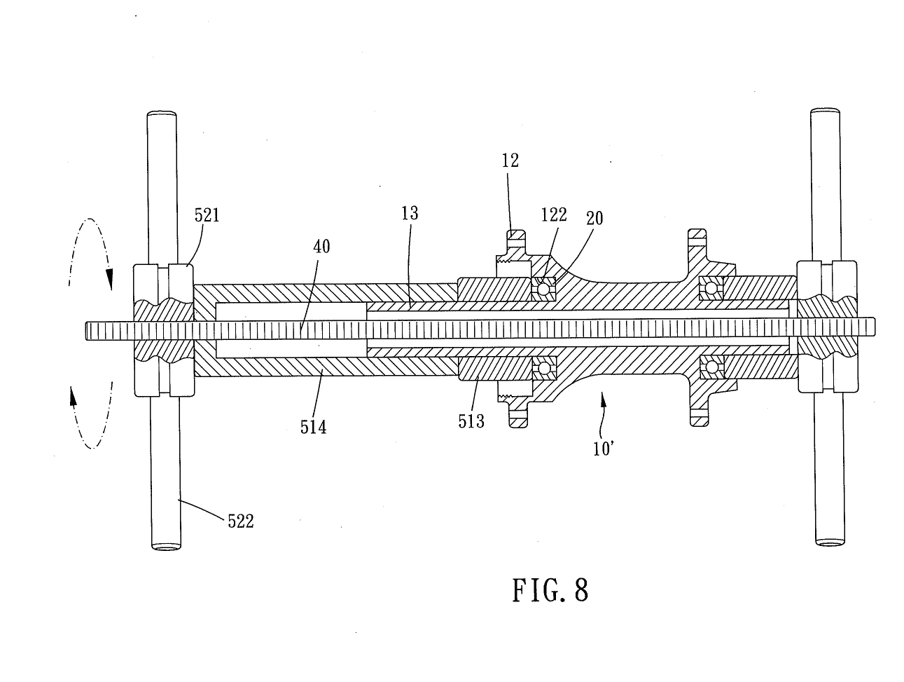

Please refer to FIGS. 7 and 8. Before the bearing is installed, operation of the present embodiment is similar to the one of the previous embodiment. When installing, one of the bearings 20, one of the first columns 513, and one of the second columns 514 are sleeved onto one of the axle 13 one by one. In other words, the axle 13 is inserted into the large hole 511, and the threaded rod 40 is inserted through the large hole 511 and the reduced hole 512 wherein an internal diameter of the reduced hole 512 is substantially equal to the external diameter of the threaded rod 40 so that the threaded rod 40 is positioned in the reduced hole 512 of the second column 514 without shaking. Thereafter, the rotating body 521 of one of the rotating element is screwed to the threaded rod 40, and the shafts 522 are held to rotate the rotating bodies 521 so that each rotating body 521 is moved along the threaded rod 40 toward the bearing 20. The rotating body 521 is able to push the second column 514, and then the first column 513 is further pushed by the second column 514. The first column 513 further pushes the bearing along the axle 13 until the bearing is pushed into the receiving room 122, as shown in FIG. 8.

The bearings 20 and the pushing elements 51 are sleeved onto the sleeved tube 30 or the axes 13 respectively to prevent from contacting the threaded rod 40. Thereby, internal surfaces of the bearings 20, internal surfaces of the pushing elements 51, and the threads on the threaded rod 40 may not be abraded. Specifically, the smooth surface of the first embodiment is most preferred.

On the other hand, the sleeve tube 30 and the second column 514 help stabilize the threaded rod to prevent from being shaken with respect to the hub 10, 10′ so that the bearing 20 is able to be pushed into the receiving room 122 easily.

Moreover, the two shafts 522 are adapted for being held to rotate the rotating bodies 521 so that the bearings 20 can be pushed into the receiving rooms 122 without any other tools.

Besides, in the second embodiment, the first column 513 and the second column 514 are able to be separated from each other. Thereby, the first column 513 in appropriate size can be utilized according to sizes of the bearings 20 so that the force by the first column 513 is able to be distributed over the bearings 20. Thus, the bearing 20 may not deform. In other possible embodiments, the first column 513 and the second column 514 can be formed integrally.

What is claimed is:

1. A bearing installer for hub, adapted for installing a bearing onto a hub, the hub having a receiving room and an axle hole, the receiving room being formed at an end of the hub and communicating with the axle hole, the bearing installer for hub including:
a sleeve tube, detachably disposed in the receiving room and the axle hole, at least an end of the sleeve tube being protruded above an end of the hub for the bearing to be sleeved onto the sleeve tube, the sleeve tube forming a through hole;
a threaded rod, inserted in the through hole of the sleeve tube, an external diameter of the threaded rod being substantially equal to an internal diameter of the through hole;
a pushing device, screwed onto the threaded rod, the pushing device being able to abut against the bearing and to be moved along the threaded rod so that the bearing is able to be pushed along the sleeve tube into the receiving room of the hub for fixation.

2. The bearing installer for hub of claim 1, wherein the pushing device includes a pushing element and a rotating element, the pushing element is slidably disposed on the sleeve tube, the rotating element is screwed to the threaded rod and is able to move toward the bearing or away from the bearing, the rotating element is able to abut against the pushing element, the rotating element is moved along the threaded rod so that the pushing element is pushed along the sleeve tube toward the bearing until the bearing is pushed into the receiving room by the pushing element.

3. The bearing installer for hub of claim 2, wherein the rotating element includes a rotating body and at least one shaft, the rotating body is screwed on the threaded rod, the shaft is protruded at an end of the rotating body.

4. The bearing installer for hub of claim 1, wherein an external diameter of the sleeve tube is substantially equal to an internal diameter of the axle hole.

5. A bearing installer for hub, adapted for installing a bearing onto a hub, the hub having a receiving room, an axle, and an axle hole, the receiving room being formed at an end of the hub, the axle being axially protruded from a face of the receiving room near the axle hole and surrounding the axle hole, the bearing being slidably sleeved onto the axle, the axle defining a through hole, the through hole communicating with the axle hole, the bearing installer for hub including:
a threaded rod, inserted into the through hole of the axle and the axle hole of the hub;
a pushing device, including a pushing element and a rotating element, the pushing element forming a large hole and a reduced hole, the large hole communicating with the reduced hole, the axle being inserted into the large hole, the threaded rod being inserted through the large hole and the reduced hole, the rotating element being screwed to the threaded rod and being able to move along the threaded rod toward the bearing or away from the bearing, when the rotating element abuts against the pushing element, the rotating element is moved along the threaded rod to push the pushing element so that the pushing element is moved along the axle toward the bearing to push the bearing into the receiving room;
wherein an internal diameter of the reduced hole is substantially equal to an external diameter of the threaded rod.

6. The bearing installer for hub of claim 5, wherein the pushing element includes a first column and a second column, the large hole includes a first section and a second section, the first section of the large hole is formed in the first column, the second section of the large hole and the reduced hole are formed in the second column, the reduced hole communicates with the second section of the large hole, when the rotating element abuts against the second column, the rotating element is moved along the threaded rod to push the second column, the second column further pushes the first column so that the bearing is pushed along the axle by the first column until the bearing is moved into the receiving room for fixation.

7. The bearing installer for hub of claim 5, wherein the rotating element includes a rotating body and at least one shaft, the rotating body is screwed on the threaded rod, the shaft is protruded at an end of the rotating body.

8. The bearing installer for hub of claim 6, wherein the rotating element includes a rotating body and at least one shaft, the rotating body is screwed on the threaded rod, the shaft is protruded at an end of the rotating body.
